(19) United States
(12) Patent Application Publication
(10) Pub. No.: US 2006/0267311 A1
(43) Pub. Date: Nov. 30, 2006

(54) Interior trimming piece

(76) Inventor: Albert Brandstatter, Odelzhausen (DE)

Correspondence Address: Fay Kaplun & Marcin, 150 Broadway, Suite 702, New York, NY, 10038, US

(21) Appl. No.: 10/543,519

(22) PCT Filed: Jan. 29, 2004
(86) PCT No.: PCT/EP04/00803

§ 371 Date: May 8, 2006

(30) Foreign Application Priority Data
Jan. 29, 2003 (DE) 10304198.2

(51) Int. Cl. B60R 21/215

(52) U.S. Cl. 280/728.3; 280/732

(57) ABSTRACT

Described is an interior trimming piece which includes (a) a plastic substrate; and (b) a metal reinforcing piece connected to the substrate. The metal reinforcing piece includes a hinge sheet for bridging a channel for passage of an airbag in at least one region. The hinge sheet, the substrate and at least one recess situate at least one fixing element which is engaged behind the recess for coupling of the hinge sheet and a portion of the substrate. A gap is provided between an inner edge of the recess and the fixing element to equalize an thermal expansion between the fixing element and the recess.

The present invention concerns an interior trimming piece according to the introductory part of patent claim 1.

For such interior trimming pieces, in particular in modern motor vehicles there arises the object of not only being lightweight and environmentally friendly, but also affording opportunities for the passage of airbag modules arranged behind the interior trimming piece.

Thus a generic interior trimming piece for motor vehicles is known, which has a plastic substrate and, connected thereto, a metal reinforcing piece provided with a hinge sheet for bridging a channel for passage of an airbag in at least one region. This metal reinforcing piece is e.g. a sheet metal piece which is riveted to the plastic substrate and which has a predefined bending edge, so that in case of release of an airbag this bending edge serves as a hinge for an airbag flap, while the plastic substrate is torn open in the region of the airbag channel.

The metal piece here also has the object of providing a rigid closure for the airbag channel during normal running of the vehicle.

A disadvantage of all generic interior trimming pieces known in the state of the art is, however, that a join of the plastic substrate to the metal reinforcing piece is visible because, particularly e.g. after intensive solar radiation, arches or rivet heads stand out through a decorative layer which seals off from the interior of the motor vehicle.

It is therefore the object of the present invention to provide interior trimming pieces for motor vehicles, which on the one hand are cheap to make and on the other hand have invisible openings for passage of airbags.

This object is achieved by an interior trimming piece according to claim 1.

Due to the fact that, in a generic interior trimming piece, the hinge sheet of the metal reinforcing piece and the plastic substrate contain at least one recess and, corresponding thereto, at least one fixing element engaging behind this recess, for coupling of hinge sheet and substrate piece, wherein between the inner edge of the recess and the fixing element there is a gap to equalise thermal expansion between fixing element and recess, this object is achieved.

Various embodiments are conceivable in this case. Thus, it is possible for the hinge sheet to have hole-like recesses in which engage fixing elements of the substrate piece, which engage behind like pins. Naturally, in a modification of this it is also possible for there to be a reversal of these conditions, i.e. the fixing elements are arranged on the hinge sheet and engage in recesses of the plastic substrate piece. Naturally, combined forms are possible too.

According to the invention, in each case the result is that the “bimetal effect”, which is responsible e.g. for arching of the plastic substrate in case of severe heating, is eliminated. This stems from the fact that e.g. plastic (and therefore the plastic substrate) shows a different thermal expansion behaviour to metal, so that usually, e.g. when components are riveted on, upon heating there is inevitably deformation of the two components to different extents. This is prevented from the outset according to the invention because thermal expansion zones are provided sufficiently.

According to the invention it is therefore possible, in particular for PVC film-backed instrument panels, to provide invisible airbag openings. Due to the cantilever mounting of the airbag hinge plate relative to the airbag flap, the bimetal effect which would unavoidably occur with a change of air temperature from −40 degrees Celsius to +80 degrees Celsius, due to the coefficient of expansion of plastic being 10 times higher than metal, is disabled. In spite of the “cantilever mounting according to the invention”, the connection is guaranteed, and it is not possible for the flap to come away from the hinge plate when the airbag is fired. The bimetal effect would inevitably lead in the cold/heat test from the desired invisible airbag contour to the visible airbag contour unwanted by vehicle manufacturers. This bimetal would have an effect particularly in case of backing with PVC foam film. Hence according to the invention absolute invisibility of the airbag opening is possible, from low temperatures of −40 degrees Celsius to high temperatures in the vehicle up to +85 degrees Celsius.

Advantageous developments of the present invention are described in the dependent claims.

One advantageous development provides that the plastic substrate completely covers the airbag channel. This ensures that in the normal state extensive protection of the airbag module underneath is guaranteed. Here, the plastic substrate can have a predetermined break line round the channel for exit of the airbag (preferably below the decorative layer visible to the vehicle passengers, e.g. on the reverse side of the plastic substrate), to guarantee invisibility of the airbag channel. For this purpose it is moreover possible for the hinge sheet of the metal reinforcing piece to be mounted on the side of the plastic substrate facing away from the motor vehicle interior. The plastic substrate can, depending on the desired appearance or feel, be covered with foam and/or a decorative film on the side facing towards the motor vehicle interior. The decorative structure can be e.g. made of leather or a plastic such as PVC, also a suitable PVC foam film e.g. 1.5 mm thick can be applied in order to obtain a pleasant feel and good appearance cheaply, and for this purpose e.g. backing with a PVC foam film no. 34 2.5 mm thick Bayblend T85 is possible.

The plastic substrate can preferably also be constructed in several layers. For this purpose the plastic substrate has e.g. on the side facing towards the motor vehicle interior a preferably continuous layer of foam and/or further decorative layers. Among them, the plastic substrate may have a further piece which primarily serves for stability. This piece is made e.g. of ABS or ABS/PC and is 0.5 to 3 mm, preferably 2 to 3 mm, optimally 2.5 mm, thick. This ensures that the plastic substrate is self-supporting.

The metal reinforcing piece can be a metal sheet with a thickness from 0.5 to 1.5 mm, preferably 0.7 to 0.9 mm. In particular, low-tensile metal sheet is possible as the material, e.g. “tin metal” (material DX50). With these materials for the metal reinforcing piece it is ensured that on the one hand there is sufficient stability of bridging the channel for passage of the airbag and on the other hand there is an assured hinge function upon passage of an airbag.

The metal reinforcing piece can be constructed in different ways. For stability it is particularly advantageous that the metal reinforcing piece is frame-like with a central hinge sheet connected to the frame via a bending edge. To improve the predefined tear-open behaviour, in this case it is sensible to additionally connect the frame-like metal reinforcing piece to the plastic substrate in the edge region. It turned out that in this case a cantilever mounting is not absolutely necessary. It turned out that, for the number of recesses, 1-10 recesses, preferably 6-9 recesses (depending on the size and layout of the airbag) are sensible. In a preferred embodiment in which a plastic substrate has towards the interior a “decorative surface” with an e.g. PVC foam film and, underneath, for reasons of stability a harder plastic, e.g. ABS, it is e.g. possible to provide the cantilever mounting between hinge sheet and plastic substrate only in the region of the decorative surface. That is to say, the “stability-forming” portion of the plastic substrate is hollowed out in this region and here completely bridged by the hinge sheet. The “cantilever” mounting takes place in each case between recesses (holes) in the hinge sheet and plastic domes which protrude from the decorative surface on the side facing away from the interior and engage behind these recesses. As a result there is on the one hand a stable airbag flap, but on the other hand a lightweight airbag flap which can be torn open in a predefined manner and which can also be made invisible.

In particular, it turned out that it is advantageous to make the recesses slot-like or oval and to make the fixing elements corresponding thereto in cross-section, as the thermal expansion behaviour seems particularly favourable here. In a modification of this it is possible for the recesses to have a graduation in their inner edge region. A further advantageous development provides that between recess and fixing element only in one plane is there play for thermal expansion. This means e.g. that, with a fixing element which is designed e.g. as a “dome” engaging behind the recess, this process of engaging behind takes place in such a way that at normal temperatures the section engaging behind rests on top without stress (but without a gap) in the axial direction of the dome. This is not a problem in case of greater temperature fluctuations either, as the principal thermal expansion takes place in the surface plane perpendicular to this axial direction. It is favourable to provide play in one plane only, in order to prevent any rattling of the components against each other, which might produce unwanted noise.

The fixing elements can basically be any elements engaging behind openings. Thus they can be e.g. plastic domes formed integrally on e.g. the plastic substrate. These are slightly melted or ultrasonically welded e.g. to produce their shape which engages behind, so that a “mushroom shape” which engages behind the recesses can be produced.

Naturally, it is also possible for the fixing elements to be separate components which engage behind the remainder of the plastic substrate or parts thereof. These can be e.g. screws made of metal or plastic. They can engage behind e.g. by additional nuts too here, and riveting is also conceivable (but with a gap in the surface).

Basically, the invention can be employed for all interior trimming pieces in motor vehicles, regardless of whether it is an instrument panel, a side trim or e.g. the headspace region of a motor vehicle.

Further advantageous developments of the present invention are described in the other dependent claims. The invention will now be described with the aid of several figures. They show:

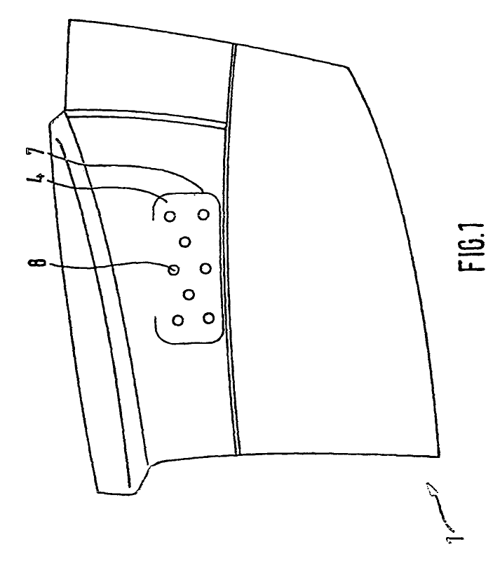

FIG. 1 the view of an interior trimming piece according to the invention from the interior of the motor vehicle;

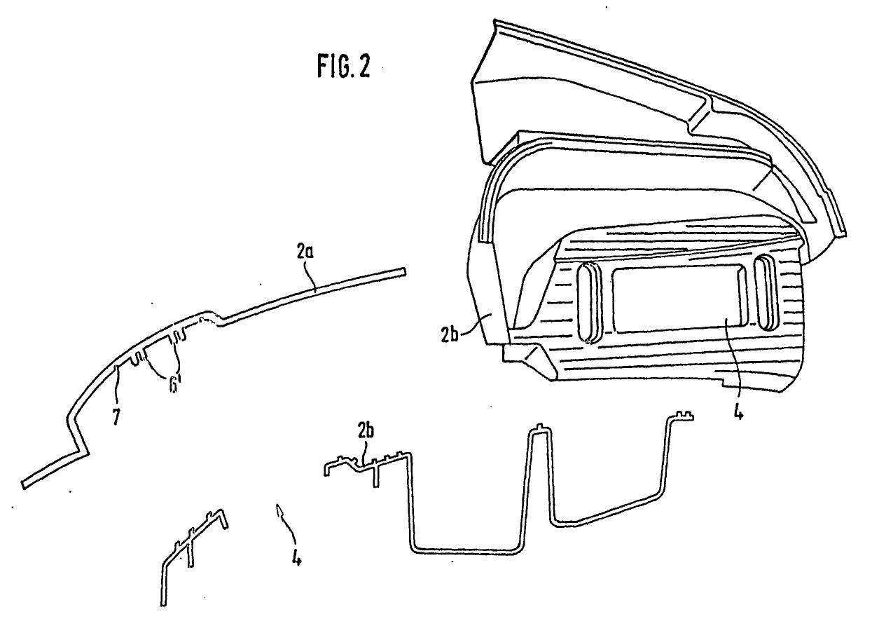

FIG. 2 components of a multi-piece plastic substrate;

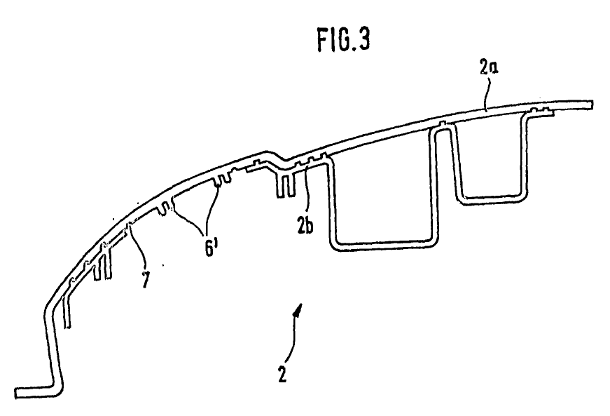

FIG. 3 the components as in FIG. 2 in the joined-up form;

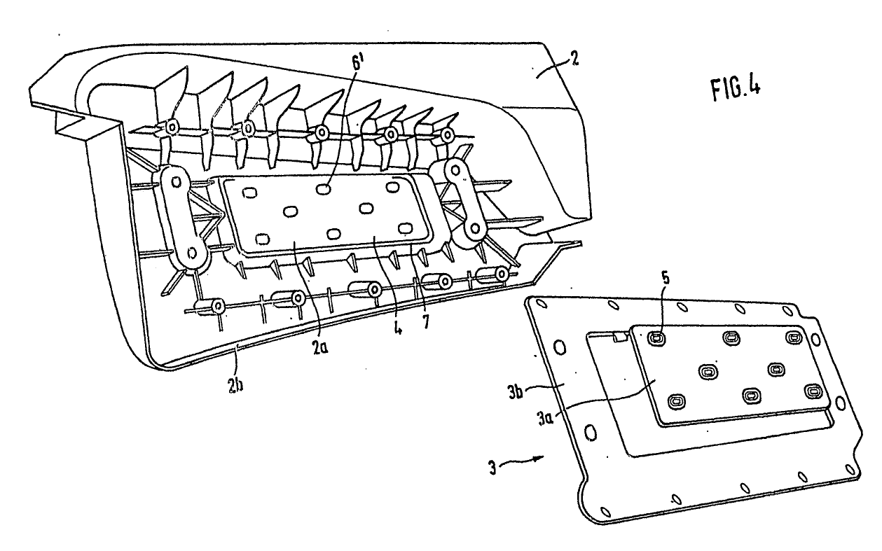

FIG. 4 part of a plastic substrate according to the invention with a metal reinforcing piece according to the invention;

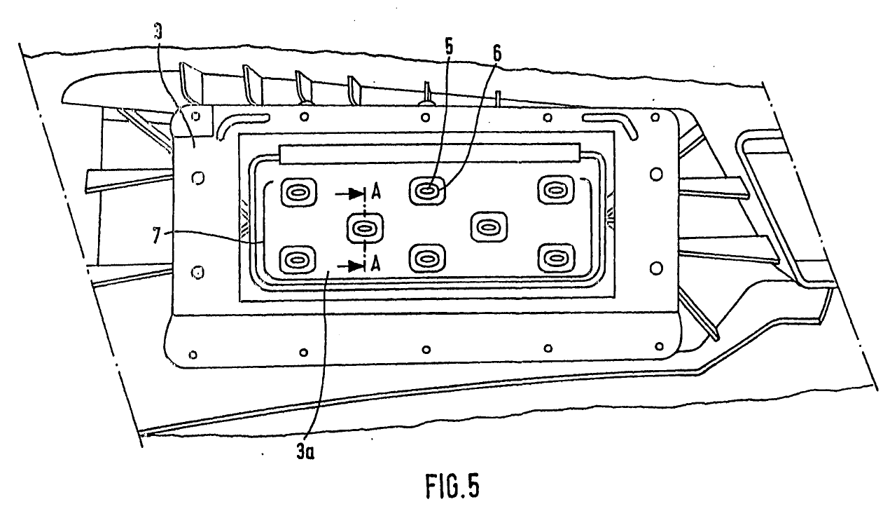

FIG. 5 a view of an interior trimming piece according to the invention as in FIG. 1 seen from the side facing away from the motor vehicle interior; and

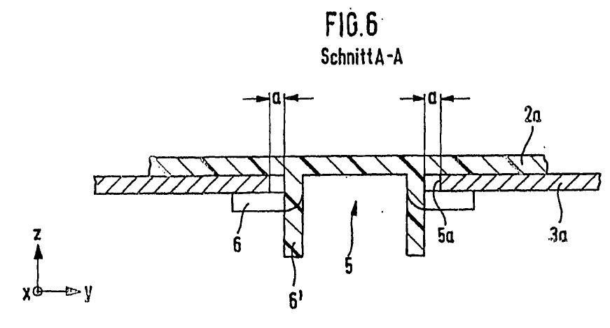

FIG. 6 a section through the interior trimming piece as in FIG. 5 along A-A.

FIG. 1 shows an interior trimming piece 1 according to the invention, seen from the interior of a motor vehicle. This interior trimming piece has an airbag system which is normally “invisible” to the vehicle passengers. Only for illustration are there therefore provided in FIG. 1 a predetermined break line 7 of the interior trimming piece (which is applied e.g. on the reverse side and hence invisible) and pairs of fixing elements and recesses according to the invention, which in FIG. 1 are constructed as a total of eight points (see reference number “8”) which will be considered in more detail again later and which normally likewise are not visible from the vehicle interior. The predetermined break line 7 forms the outer contour of an airbag channel 4 for passage of an airbag into the interior of the motor vehicle. The interior trimming piece shown in FIG. 1 forms part of an instrument panel of a modern motor vehicle.

Below, the construction of a plastic substrate which is contained in the interior trimming piece is described.

FIG. 2 shows elements of a two-piece plastic substrate. This has to begin with a lower portion 2b which serves primarily for stability and rigidity of connection. This portion 2b is shown once (at the bottom) in cross-section. In this case it can be seen clearly that there is an aperture in the region of the airbag channel 4. This can also be seen again in the other view of the portion 2b which is shown at the top right in FIG. 2. Here too is shown a channel 4 for passage of an airbag. On the surface in the view top right of the portion 2b can be seen lines along the upper surface of this portion 2b. These parts serve for better fixing of a portion 2a which is to be applied to the portion 2b (preferably by melting (e.g. ultrasonic melting, or by gluing) and which is shown at the top left in FIG. 2. The portion 2b is made of a stable plastic, e.g. ABS, and is e.g. 2.5 mm thick.

On the portion 2b is laid the portion 2a. This is a PVC foam film which towards the interior of the motor vehicle (that is, to the top left in FIG. 2) has a smooth film which is lined with a foam. Naturally, other embodiments are possible too, e.g. an additional decoration with leather etc. is provided or a foam filling for making an even thicker foam layer. The portions 2a and 2b are joined in such a way that the plastic substrate 2 shown in FIG. 3 results. Here, it should already now be pointed out that the predetermined break line 7 shown in FIG. 1 is located in the edge region of the airbag channel 4, and that “dome blanks” 6′ are provided which, after subsequent melting of their ends, will form fixing elements according to the invention.

The plastic substrate 2 shown in FIG. 3 has a shape which meets any demands of design. The embodiment shown in FIG. 3 shows an instrument panel. For this purpose, in particular additional channels, for example, for air conduction, can be provided in the lower portion 2b.

FIG. 4 shows again a detail of the plastic substrate 2 from its “reverse side”, that is, from the side facing away from the motor vehicle interior in the fitted state. Here it can be seen that the airbag channel 4 is closed by the portion 2a. Moreover, the “dome blanks” 6′ can be seen. On these dome blanks is placed a hinge sheet 3a with recesses 5, as can be seen in FIG. 4. The recesses 5 of the hinge sheet 3a match the dome blanks 6′ in shape. The hinge sheet belongs to a metal reinforcing piece 3 which is frame-like with the centrally arranged hinge sheet 3a. The metal reinforcing piece further has in its edge region 3b holes which serve to fix this edge region to the reverse side of the plastic substrate 2 in corresponding receptacles. The metal reinforcing piece is a deep-drawn sheet metal piece (tin metal) which has a continuous thickness of 0.8 mm. The metal reinforcing piece (or the hinge sheet) is mounted on the side of the plastic substrate 2 facing away from a motor vehicle interior, at least the portion 2a of the plastic substrate covering the airbag channel 4.

It should be noted that the metal reinforcing piece 3 and the plastic substrate 2 are shaped in such a way that the hinge sheet 3a in the joined position of metal reinforcing piece 3 and plastic substrate 2 offers planar support of the section 2a which covers the airbag channel 4. Only as a result of this does the desired invisible appearance arise, as the hinge sheet 3a thus follows the overall contour of the interior trimming piece 1.

Following FIG. 4, melting of the dome blanks 6′ takes place, so that the latter engage behind the recesses 5 of the metal reinforcing piece 3 or hinge sheet 3a.

This state is shown in FIG. 5. It can be seen clearly how, with the 8 recesses 5, fixing elements 6 which are complementary in shape (but smaller) engage.

This process of engaging behind can take place by ultrasonic welding or by thermal melting of the dome blanks 6′. Naturally, in other embodiments it is also possible to use external components here, such as screws made of metal or plastic. In FIG. 5 it can be seen particularly clearly that the fixing elements 6 have an oval cross-sectional structure. This is particularly advantageous for the desired thermal expansion behaviour, because here attachment of plastic substrate and hinge element over a large area on the one hand is achieved, and yet no adhesion over the whole surface, which might lead to arching in case of temperature changes.

In FIG. 5 the hinge sheet 3a has in the edge region of the recesses 5 a “graduation” from the plastic substrate portion 2a.

The essential aspect of the “cantilever” mounting could not be seen directly in the drawings so far. Therefore to illustrate this circumstance (which is present in all embodiments) the section A-A is shown in FIG. 6. For reasons of simplicity, however, compared with the section in FIG. 5 the graduation of the edge region of the recess 5 has not been shown.

In FIG. 6 are shown two states of the plastic substrate piece 2 or its portion 2a. Firstly can be seen pointing vertically downwards a dome blank 6′ which is inserted in a recess 5. Following ultrasonic welding, the finished design of the fixing element can be seen. Here the ends of the dome blanks 6′ are shaped so as to engage behind the recesses 5 peripherally and so fix the hinge sheet 3a. In the embodiment shown here, shaping has been effected so that the fixing element is directly adjacent in the axial direction of the fixing element or dome blank (that is, in the Z direction).

But by contrast in the X-Y plane there is a gap between the outer contour of the fixing element 6 and the inner edge of the recess Sa. This gap in the “surface plane”, that is, the X-Y plane, ensures that according to the invention there is equalisation of thermal expansion between fixing element and recess, so that no arching of the portion 2a can occur, e.g. in direction Z.

Thus in each of the preceding examples is shown an interior trimming piece 1 for motor vehicles, which has a plastic substrate 2 and, connected thereto, a metal reinforcing piece 3 provided with a hinge sheet 3a for bridging a channel 4 for passage of an airbag in at least one region. The hinge sheet 3a and the plastic substrate 2 have at least one recess 5 and at least one fixing element 6 engaging behind this recess 5, for coupling of hinge sheet and substrate piece. It can be seen clearly, particularly in FIG. 6, that between the inner edge 5a of the recess and the fixing element 6 there is a gap a to equalise thermal expansion between fixing element and recess. The size of this gap is preferably between 0.2 and 2 mm, preferably between 0.4 and 1.5 mm, particularly preferably between 0.4 and 0.8 mm.

It is particularly advantageous that according to the present invention there is an airbag cover which is invisible even in the long term, regardless of temperature circumstances. This is the case even when the interior trimming piece is provided only with a relatively thin decorative layer towards the motor vehicle interior, such as a PVC, textile or for example TPO decorative structure with a thin foam layer underneath which is then applied to the substrate portion (the sequence is therefore PVC layer/foam layer/plastic substrate portion 2a). The foam layer here preferably has a thickness of between 0.5 mm and 5 mm, preferably 1 to 3 mm.

The foam layer is not compulsory here, but improves a “soft touch” effect. It is essential that, to minimise costs (while retaining a high-quality visual impression), very thin decorative structures can be used here. These are preferably already finished decorative structures, i.e. those which do not have to be foam-backed again in a chemical process, in order thus to produce a thick foam layer. With the present invention, therefore, practically any thinner decorative layers can be used as long as they convey an impression of sufficiently high quality. The above-mentioned list of materials is meant only by way of examples here, the essential thing is a low thickness of the whole decorative structure (if this is several layers, including for example foam layer, etc.). The total thickness of the decorative structure (including all layers such as the foam layer) is here preferably not more than 5 mm, particularly preferably not more than 3 mm, most particularly preferably not more than 2 mm.

This is a significant difference from the existing “foamed” embodiments in which for example a polyurethane foam is made in a greater thickness in a chemical process.

On the basis of its long-term market observation, the applicant has acquired the knowledge that up to now it was not possible to produce “invisible” airbag covers using relatively thin decorative structures, so that the present invention here for the first time affords an opportunity to achieve an “invisible” airbag cover even in case of temperature fluctuations.

1-16. (canceled)

17. An interior trimming piece, comprising:
a plastic substrate; and
a metal reinforcing piece connected to the substrate, the metal reinforcing piece including a hinge sheet for bridging a channel for passage of an airbag in at least one region,
wherein the hinge sheet, the substrate and at least one recess situating at least one fixing element which is engaged behind the recess for coupling of the hinge sheet and a portion of the substrate and
wherein a gap is provided between an inner edge of the recess and the fixing element to equalize an thermal expansion between the fixing element and the recess.

18. The interior trimming piece according to claim 17, wherein the piece is utilized in a motor vehicle.

19. The interior trimming piece according to claim 17, wherein the substrate covers the airbag channel.

20. The interior trimming piece according to claim 19, wherein the substrate has a predetermined break line rounding the airbag channel.

21. The interior trimming piece according to claim 19, wherein the hinge sheet is mounted on a side of the substrate, the side facing away from an interior of a motor vehicle.

22. The interior trimming piece according to claim 19, wherein the substrate includes at least one of a foam and further decorative layers on a further side of the substrate, the further side facing towards an interior of a motor vehicle.

23. The interior trimming piece according to claim 17, wherein the substrate is at least partly made of ABS, the substrate being 0.5 to 3 mm thick.

24. The interior trimming piece according to claim 17, wherein the substrate is at least partly made of ABS, the substrate being 2 to 3 mm thick.

25. The interior trimming piece according to claim 17, wherein the substrate is at least partly made of ABS, the substrate being 2.5 mm thick.

26. The interior trimming piece according to claim 17, wherein the metal reinforcing piece is 0.5 to 1.5 mm thick.

27. The interior trimming piece according to claim 17, wherein the metal reinforcing piece is 0.7 to 0.9 mm thick.

28. The interior trimming piece according to claim 19, wherein the metal reinforcing piece has a frame-like shape, the hinge sheet being a centrally arranged within the frame-like metal piece.

29. The interior trimming piece according to claim 28, wherein the frame-like metal piece is connected to the substrate in an edge region of the frame-like metal piece.

30. The interior trimming piece according to claim 17, further comprising:
a plurality of recesses,
wherein a number of the recesses is between 1 and 10.

31. The interior trimming piece according to claim 30, wherein the number of the recesses is between 6 and 9.

32. The interior trimming piece according to claim 31, wherein the recesses have a slot-like shape, the fixing element having a shape corresponding the slot-like shape of the recesses.

33. The interior trimming piece according to claim 31, wherein each of the recesses has a graduation in a respective edge region.

34. The interior trimming piece according to claim 31, wherein between one of the recesses and the fixing element only in one plane is there play for the thermal expansion.

35. The interior trimming piece according to claim 17, wherein the fixing element is a plastic dome of the substrate.

36. The interior trimming piece according to claim 17, wherein the fixing element is separate a component which engages behind a remainder of the substrate.

37. The interior trimming piece according to claim 17, wherein one of an instrument panel and a side trim of a motor vehicle includes the piece.
